(19) United States
(12) Patent Application Publication
(10) Pub. No.: US 2003/0228190 A1
(43) Pub. Date: Dec. 11, 2003

(54) Connecting structure between lamp rack and switch box

(76) Inventor: Keen Hsu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/161,684

(22) Filed: Jun. 5, 2002

(51) Int. Cl. B25G 3/36

(52) U.S. Cl. 403/388

(57) ABSTRACT

The present invention relates to the connecting structure between lamp rack and switch box, and more particularly to a connecting structure that can be easily and precisely positioned, wherein the surrounding wall of the switch box includes several slots and the slot allows the square joint of the lamp rack to set in, while the top cover is pressed down onto the square joint and locked by the use of a stud or a bolt. In addition, the slots can be formed on the bottom of the switch box and the bending tube of the lamp rack can be inserted into the cutoff of the reinforce plate, so the square joint of the lamp rack can be inserted into the slot and the top cover and the reinforce plate are locked by a stud or a bolt.

### BACKGROUND OF THE INVENTION

(1) Field of the Invention

The present invention relates to the connecting structure between lamp rack and switch box, and more particularly to a connecting structure that can be easily and precisely positioned by the use of slot and the tenon of square joint.

(2) Description of the Prior Art

Please refer to FIG. 1 and FIG. 2, the schematic view of a ceiling lamp currently on the market, wherein the surrounding wall of the switch box 11 includes several holes 111, and the hole 111 allows the thread section 121 at the front end of the lamp rack 12 to be inserted in and locked up by a nut 13 and a washer 14 from the internal side of the switch box 111. Please refer to FIG. 3 and FIG. 4, a schematic view of another embodiment of ceiling lamp currently on the market, wherein the bottom of the switch box 16 includes several holes 161, and the hole 161 allows the thread section 171 at the front end of the lamp rack 17 to be inserted in and locked up by a nut 18 and a washer 19 from the internal side of the switch box 16. Although the prior structure is able to achieve ceiling lamp assembly, it may yield several shortcomings:

1. Since the lamp rack 12, 17 is locked up by a thread section 121, 171, a nut 13, 18, and a washer 14, 19, the lamp rack 12, 17 should distribute weight evenly on the switch box 11, 16, so the ceiling lamp installation is free from the risk of being crooked. In addition, the angle of every lamp rack 12, 17 should be the same, however the ordinary consumers cannot easily control the angle of each lamp rack 12, 17 during the locking of the nut 13, 18 and it requires professional personnel to accomplish the assembly.

2. As stated above, it requires professional personnel to accomplish the assembly, so the lamp rack 12, 17 cannot be removed after being assembled. It wastes packing and shipping costs because of using a large volume of packing materials. In addition, if one of the lamp racks 12, 17 is damaged, it needs to replace the entire ceiling lamp, which increases the costs for the manufacturer.

### SUMMARY OF THE INVENTION

Because of the stated shortcomings of difficult assembly between the prior switch box and lamp rack, after years of experience in the industry and a sequence of continuous researches, developments, and improvements, I propose the present invention as a possible solution.

The primary objective of the present invention is to provide a connecting structure between lamp rack and switch box that can be easily and precisely positioned, and more particularly a ceiling lamp that can be assembled by the consumer.

The second objective of the present invention is to provide a connecting structure between lamp rack and switch box that is able to replace individual lamp rack.

The further objective of the present invention is to provide a connecting structure between lamp rack and switch box that can be disassembled for packing in order to reduce packing materials and decrease shipping costs.

### BRIEF DESCRIPTION OF THE DRAWINGS

The present invention will now be specified with reference to its preferred embodiment illustrated in the drawings, in which

FIG. 1 is a schematic 3-dimensional explosion view of a first prior structure.

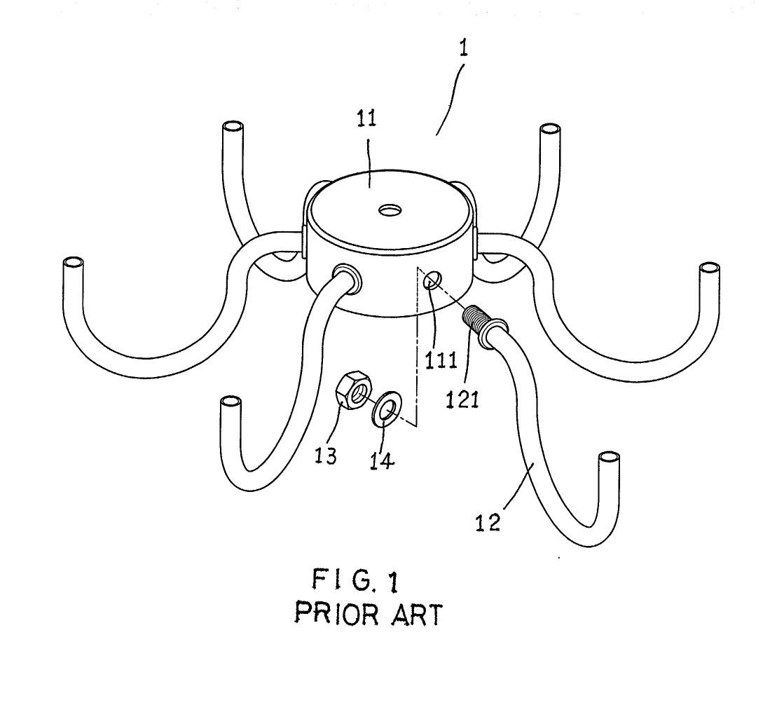

FIG. 2 is a schematic cross-section view of a first prior structure.

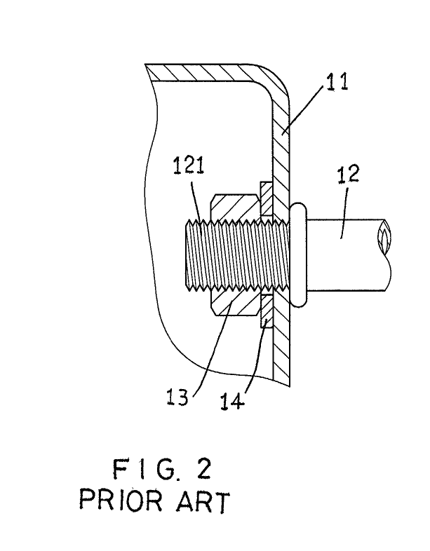

FIG. 3 is a schematic 3-dimensional explosion view of a second prior structure.

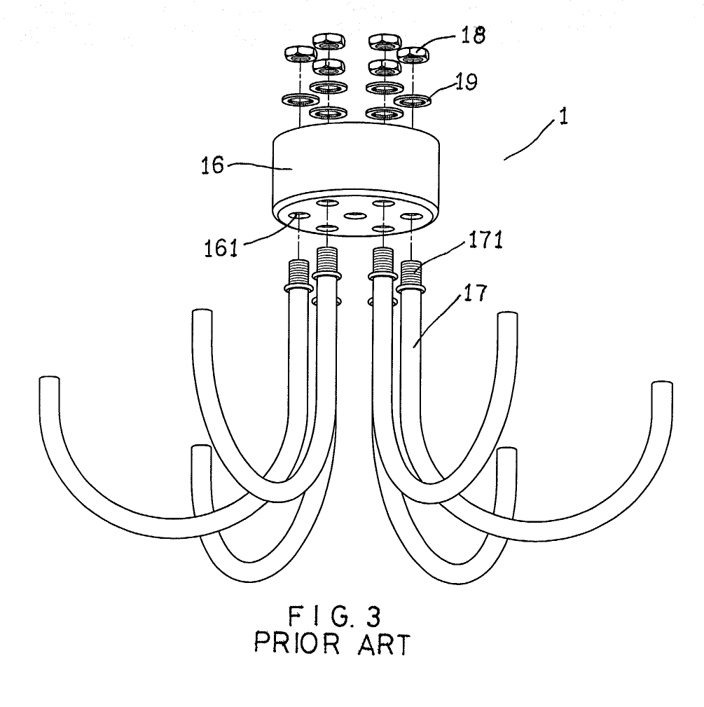

FIG. 4 is a schematic cross-section view of a second prior structure.

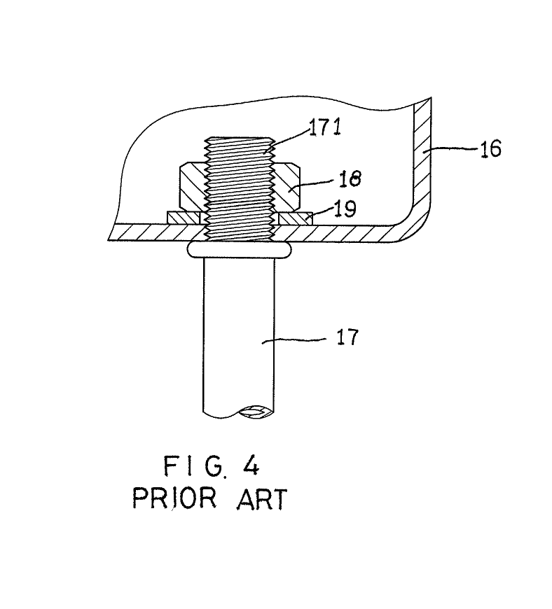

FIG. 5 is a schematic 3-dimensional explosion view of a first preferred embodiment in accordance with the present invention.

FIG. 6 is a schematic 3-dimensional assembled view of a first preferred embodiment in accordance with the present invention.

FIG. 7 is a schematic cross-section view of a preferred first embodiment in accordance with the present invention.

FIG. 8 is a schematic 3-dimensional explosion view of a second preferred embodiment in accordance with the present invention.

FIG. 9 is a schematic 3-dimensional assembled view of a second preferred embodiment in accordance with the present invention.

FIG. 10 is a schematic cross-section view of a preferred second embodiment in accordance with the present invention.

FIG. 11 is a schematic 3-dimensional explosion view of a third preferred embodiment in accordance with the present invention.

FIG. 12 is a schematic 3-dimensional assembled view of a third preferred embodiment in accordance with the present invention.

FIG. 13 is a schematic cross-section view of a preferred third embodiment in accordance with the present invention.

FIG. 14 is a schematic 3-dimensional explosion view of a fourth preferred embodiment in accordance with the present invention.

### DESCRIPTION OF THE PREFERRED EMBODIMENT

The invention disclosed herein is directed to the connecting structure between lamp rack and switch box. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

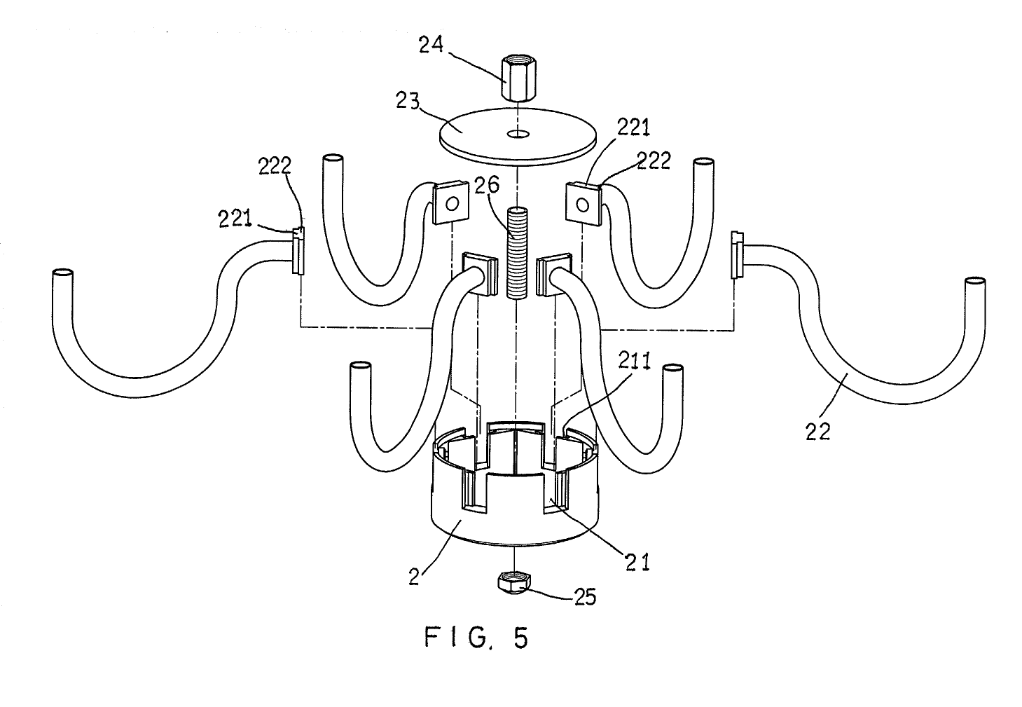

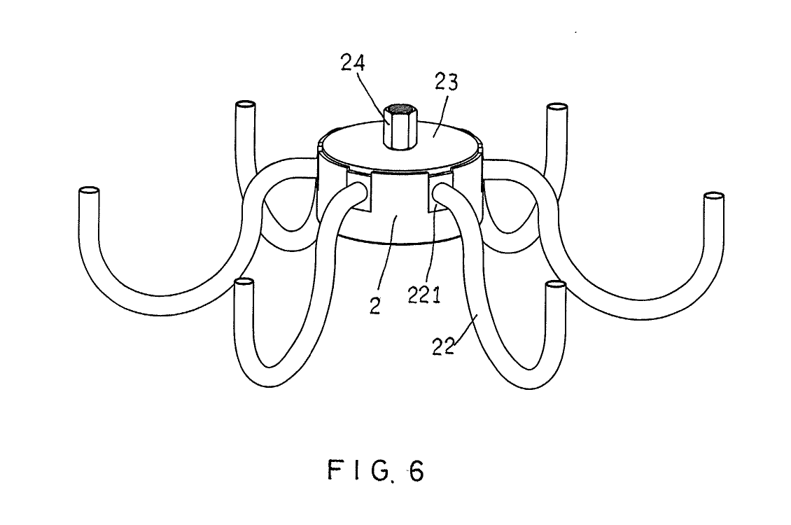

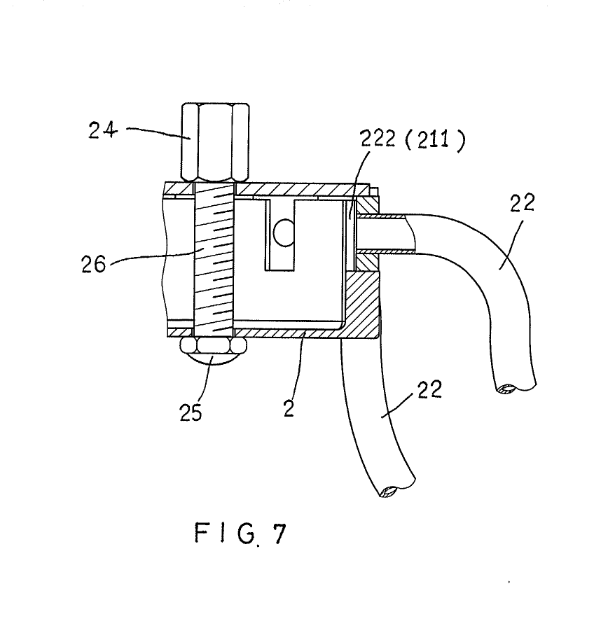

First, please refer to FIG. 5 to FIG. 7. The surrounding wall of the switch box 4 includes several cutoffs 21, wherein the cutoff 21 further includes a slot 211 and the slot 211 allows the square joint 221 at the front end of the lamp rack 22 to set in. The extended wings 222 on both sides of the square joint 221 are inserted downwards into the slots 211 and then the top cover is also placed downwards so the bottom rim of the top cover 23 is precisely pressed down onto the upper rim of the square joint 221 and locked up by the use of a top nut 24, a bottom nut 25, and a stud 26 to allow easy assembly by oneself.

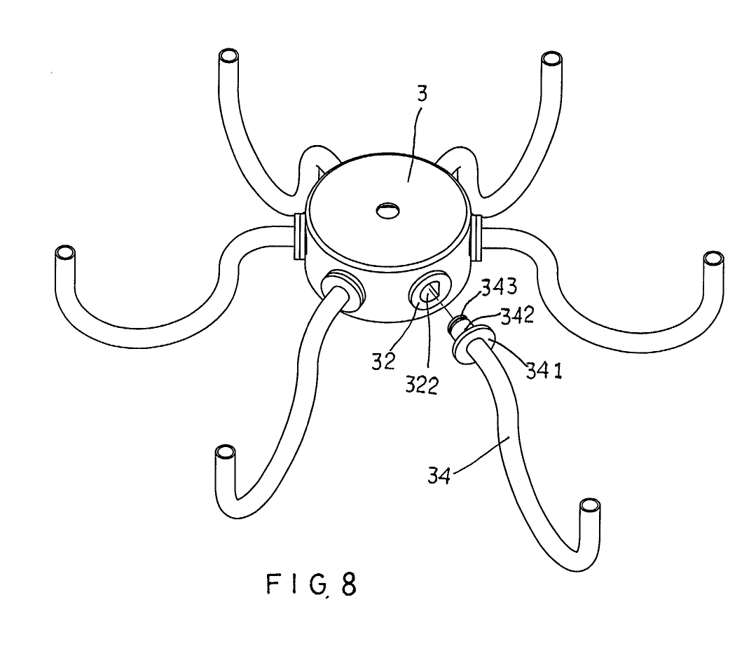

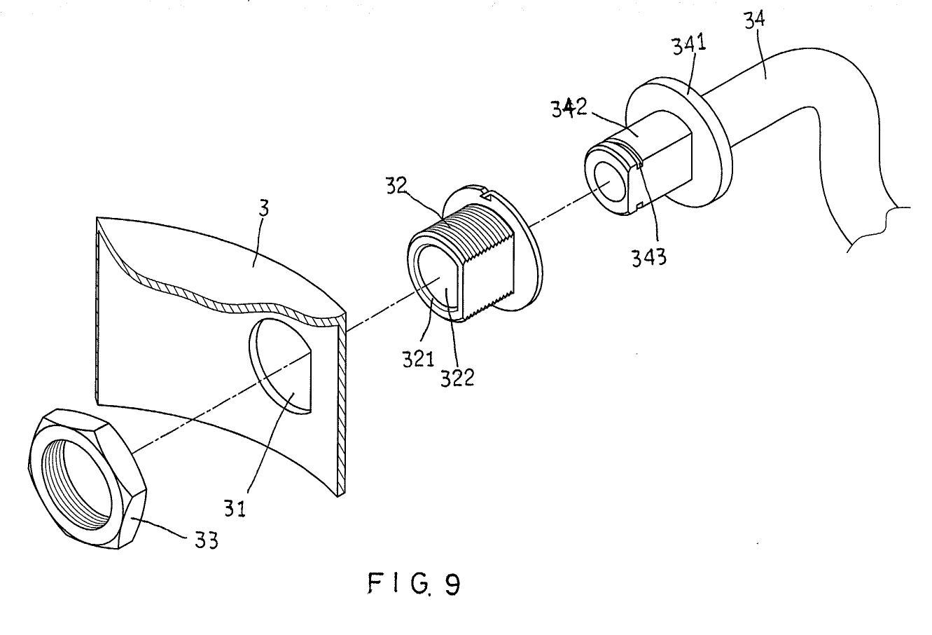

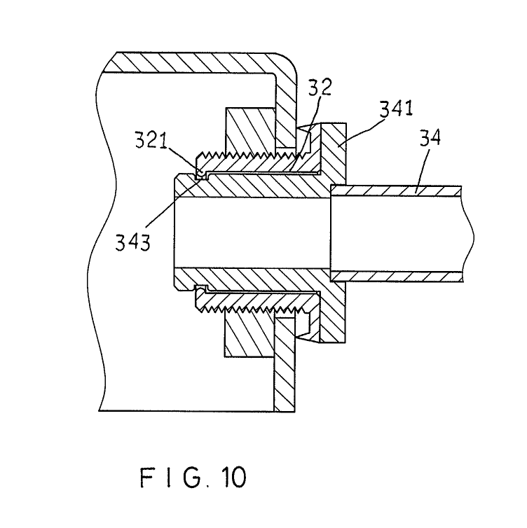

Please refer to FIG. 8 to FIG. 10, another preferred embodiment of the present invention, wherein the surrounding wall of switch box 4 includes several non-round holes 31 and the hole 31 allows a connector 32 of similar shape as the hole 31 to be inserted in. The front end of the connector 32 includes a thread section 321 to be locked up by a nut 33, and the hollow inside 322 of the connector 32 further includes a tenon rim 321, while the front end of the lamp rack 34 includes a connector extruding rim 341 and the front of the connector extruding rim 341 further includes a tenon section 342 that can be inserted into the hollow inside 322 of the connector 32. After inserting the tenon section 342 with similar shape as the hollow inside 322, the tenon rim 321 of the connector 32 can be set into the cut slot 343, so the consumers can easily assemble by themselves without the risk of having different lamp rack angles during assembly and the manufacturers can disassemble for packing to reduce shipping cost.

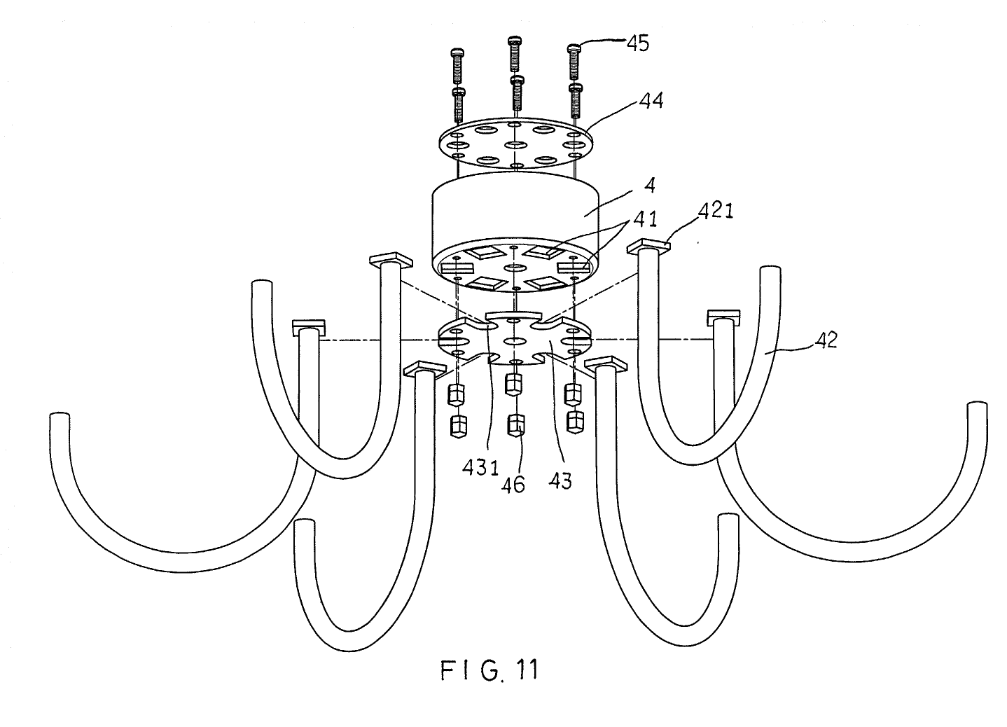

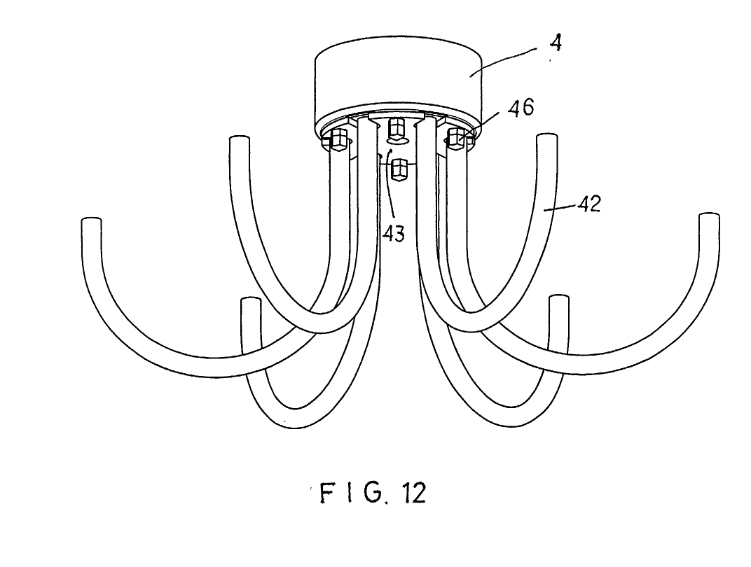

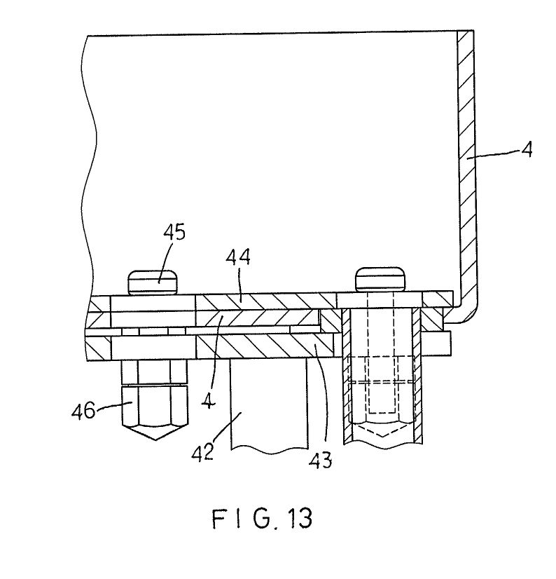

Please refer to FIG. 11 to FIG. 13, a further preferred embodiment of the present invention, wherein the bottom of switch box 4 includes several slots 41 and the square joint 421 of the lamp rack 42 can be inserted into the slot 41. It further includes a reinforce plate 43 between the switch box 4 and lamp rack 42, and around the rim of the reinforce plate 43 includes the same number of cutoffs 431 as lamp racks, wherein the width of the cutoff 431 is precisely larger than the diameter of the bending tube of the lamp rack 42 and smaller than the width of square joint 421. By the use of a bolt 45 and a nut 46 to lock up the top cover 44 with the reinforce plate 43, so the square joint 421 of the lamp rack 42 can be set into the slot 41 of the switch box 4. The consumers during the assembly process or in the need of replacement can remove or install the reinforce plate 43 and lamp racks 42 by simply loosing or locking up the nut 46, so it not only can be easily positioned, but also can be disassembled for packing to reduce ceiling lamp volume and shipping cost, and it allows consumers to assemble by themselves or replace individual lamp rack 42.

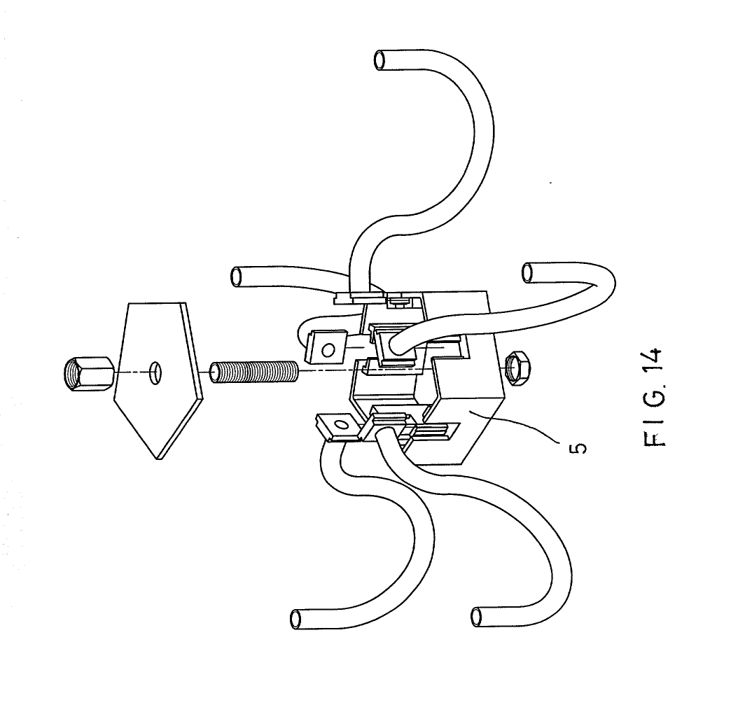

Please refer to FIG. 14, wherein the switch box 5 can be in various shapes.

While the present invention has been particularly shown and described with reference to a preferred embodiment, it will be understood by those skilled in the art that various changes in form and detail may be without departing from the spirit and scope of the present invention.

I claim:

1. A connecting structure between lamp frame and switch box, mainly comprises a switch box, a lamp rack, and a top cover, wherein the surrounding wall of said switch box includes several cutoffs and inside said cutoff further includes a slot, wherein said slot allows a square joint at the front end of said lamp rack to set in, and said top cover is precisely pressed down onto the upper rim of said square joint and locked by the use of bolt and nut.

2. A connecting structure between lamp frame and switch box according to claim 1, wherein said square joint includes two extended wings on both sides and said extended wings can be inserted into said slots of said switch box.

3. A connecting structure between lamp frame and switch box according to claim 1, wherein the surrounding wall of said switch box includes a non-round hole and said hole allows a connector of similar shape as said hole to be inserted, while the front end of said connector includes a thread section to be locked onto said switch box by a nut and said connector includes a hollow inside for a tenon section of said lamp rack to be inserted in, so a tenon rim of said connector can be set into a cut slot of said tenon section.

4. A connecting structure between lamp frame and switch box according to claim 1, wherein the bottom of said switch box includes several slots and a square joint of said lamp rack can be inserted into said slot, wherein between said switch box and said lamp rack includes a reinforce plate, and said top cover and said reinforce plate are locked up by the use of a bolt and a nut, so said square joint of said lamp rack can be set into said slot.

5. A connecting structure between lamp frame and switch box according to claim 4, wherein around the rim of said reinforce plate includes the same number of cutoffs as said lamp racks, and the width of said cutoff is precisely larger than the diameter of said lamp rack and smaller than the width of said square joint.

6. A connecting structure between lamp frame and switch box according to claim 1 or claim 2, wherein said switch box can be in various shapes.
